(19) United States
(12) Patent Application Publication
(10) Pub. No.: US 2026/0124726 A1
(43) Pub. Date: May 7, 2026

(54) WORKING MACHINE

(71) Applicant: Koki Holdings Co., Ltd., Tokyo (JP)

(72) Inventors: Tatsuhiro Tago, Ibaraki (JP); Toshinori Yasutomi, Ibaraki (JP); Tomomasa Nishikawa, Ibaraki (JP)

(21) Appl. No.: 18/940,184

(22) Filed: Nov. 7, 2024

(51) Int. Cl. B25C 1/06; B25C 1/00

(52) U.S. Cl. CPC B25C 1/06; B25C 1/008

(57) ABSTRACT

Provided is a working machine capable of improving workability. A working machine includes an electric motor, a gearbox, a wind-up wheel, a plunger, a spring, a trigger, and a housing, and in a first direction, an end portion of the gearbox on one side is located on the other side with respect to an end portion of the trigger on the other side. As a result, since the center of gravity G of the working machine and the trigger can be brought close to each other, the workability can be improved.

### TECHNICAL FIELD

The present invention relates to a working machine including a drive unit, a deceleration unit, an operation unit, a movement unit, and a manipulating unit.

### BACKGROUND ART

Patent Document 1 describes a working machine including a deceleration unit that decelerates and outputs the driving force of a drive unit, an operation unit that moves the movement unit by the output of the deceleration unit, and a manipulating unit that controls driving of the drive unit, in which the deceleration unit is disposed below the manipulating unit.

### RELATED ART DOCUMENTS

### Patent Documents

Patent Document 1: Japanese Unexamined Patent Application Publication No. 2019-087637

### SUMMARY OF THE INVENTION

### Problems to be Solved by the Invention

In the working machine described in Patent Document 1, it is necessary to provide a space for inserting a worker's finger below the manipulating unit. However, when the manipulating unit is separated to the upper side from a heavy object such as the deceleration unit or the drive unit in order to provide such a space, the manipulating unit and a handle provided with the manipulating unit are separated from the center of gravity of the working machine, and the worker is easily tired. Thus, there is room for improvement in workability. Further, separation of the manipulating unit to the upper side leads to an increase in size of the entire working machine.

An object of the present invention is to provide a working machine capable of improving workability. Another object of the present invention is to provide a working machine which can be reduced in size.

### Means for Solving the Problems

A working machine of one embodiment includes a movement unit that moves downward to strike a stopper, a biasing unit that biases the movement unit downward, an operation unit that lifts the movement unit upward against the biasing force of the biasing unit, a drive unit having a drive shaft extending in a front-rear direction, a deceleration unit disposed between the drive unit and the operation unit in the front-rear direction and configured to decelerate and output the driving force of the drive unit, a transmission unit that transmits the output of the deceleration unit to the operation unit, a housing having a drive unit case housing the drive unit, the transmission unit, and the operation unit, and a handle located above the drive unit case and extending in the front-rear direction, and a manipulating unit protruding downward from the handle. The drive unit case has a drive unit housing surface which is the upper surface of a portion housing the drive unit and a constricted portion which is the upper surface of a portion housing the transmission unit and is located lower than the drive unit housing surface, and the lower end of the manipulating unit is disposed lower than the drive unit housing surface.

A working machine of another embodiment includes a movement unit that moves downward to strike a stopper, a biasing unit that biases the movement unit downward, an operation unit that lifts the movement unit upward against the biasing force of the biasing unit, a drive unit having a drive shaft extending in a front-rear direction, a deceleration unit disposed between the drive unit and the operation unit in the front-rear direction and configured to decelerate and output the driving force of the drive unit, a transmission unit that transmits the output of the deceleration unit to the operation unit, a housing having a drive unit case housing the drive unit, the transmission unit, and the operation unit, and a handle located above the drive unit case and extending in the front-rear direction, a manipulating unit protruding downward from the handle, and an ejection unit fixed to the housing and configured to eject the stopper struck by the movement unit. The lower end of the manipulating unit is disposed lower than the center between the upper end of the housing and the lower end of the ejection unit in an up-down direction.

### EFFECTS OF THE INVENTION

In the working machine of one embodiment, an end portion of the deceleration unit on one side is located on the other side with respect to an end portion of the manipulating unit on the other side in a first direction. As a result, the center of gravity of the working machine and the manipulating unit can be brought close to each other, so that the workability of the working machine can be improved.

Further, in the working machine of one embodiment, the outer diameter of a coupling shaft coaxially coupling the deceleration unit and the operation unit is smaller than that of the deceleration unit, and the coupling shaft is disposed at a position overlapping with at least part of the manipulating unit in a second direction. As a result, separation of the manipulating unit to the one side in the second direction can be prevented, so that the working machine can be reduced in size.

### BRIEF DESCRIPTIONS OF THE DRAWINGS

FIGS. 1A-1B are views showing a working machine according to one embodiment, FIG. 1A being a front view and FIG. 1B being a left side view;

FIG. 2 is a left side view showing an internal structure in a state of a left housing member being removed in FIG. 1;

FIG. 3 is a view showing a state of the biasing force of a spring being increased in FIG. 2;

FIG. 4 is a view showing the center of gravity in FIG. 2;

FIG. 5 is a view showing a state of illustration of a pinion shaft being omitted in FIG. 2;

FIG. 6 is a view showing a state of a nail being held in a magazine in FIG. 5;

FIG. 7 is a view showing a state in which a push lever contacting a partner member is operated in FIG. 6 (working machine with a nail);

FIG. 8 is a view showing a state in which the push lever contacting the partner member is operated in FIG. 5 (working machine with no nail); and

FIGS. 9A-9C are front views showing operation states of a wind-up wheel, a rack, a plunger, and a spring in the working machine, FIG. 9A showing a state of the plunger being at a bottom dead center, FIG. 9B showing a state of the plunger being at a standby position, and FIG. 9C showing a state of the plunger being at a top dead center.

### DETAILED DESCRIPTION OF PREFERRED EMBODIMENTS

Hereinafter, a working machine according to an embodiment of the present invention will be described with reference to the drawings.

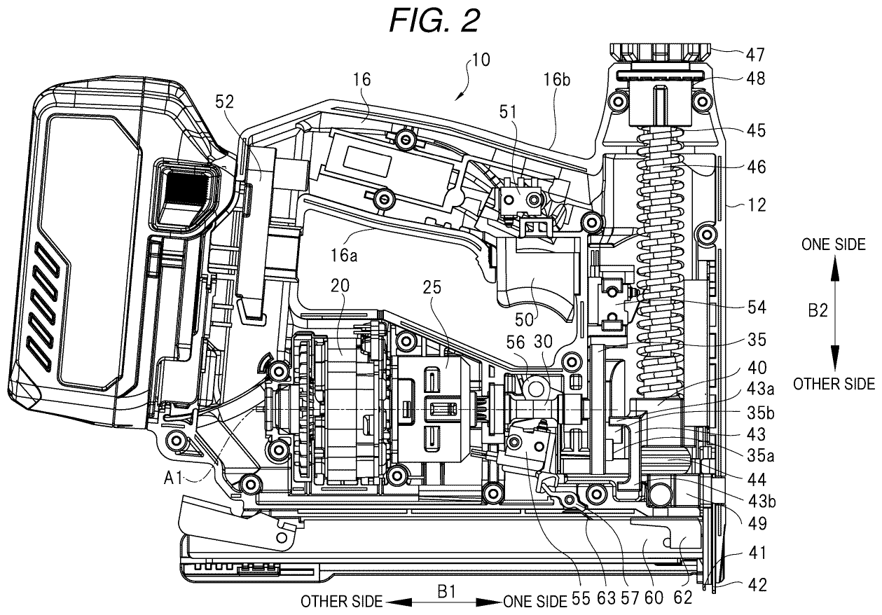

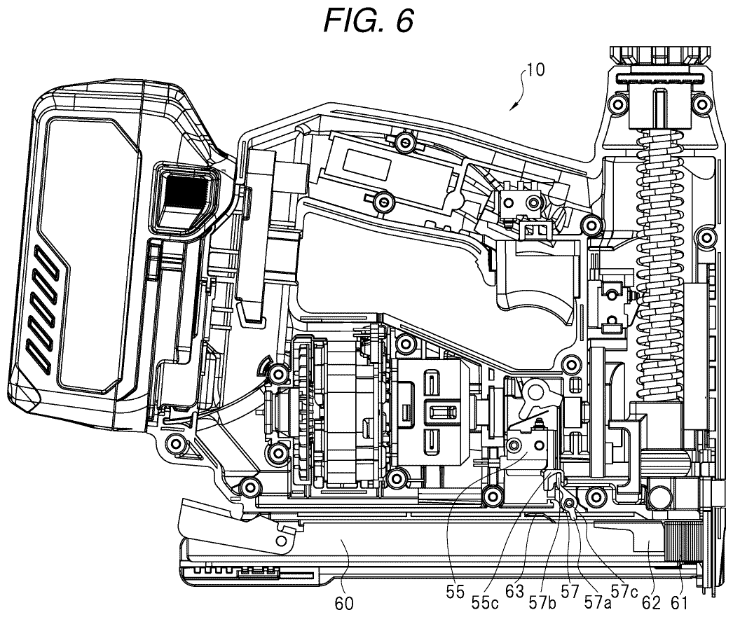

A working machine 10 is a nailing machine or a driving machine that strikes and drives a stopper (nail 61 shown in FIG. 6 in this example), and as shown in FIG. 2, includes an electric motor 20, a gearbox 25, a pinion shaft 30, a wind-up wheel 35, a plunger 40, a spring 45, a trigger 50, and the like.

Here, the electric motor 20, the gearbox 25, the pinion shaft 30, and the wind-up wheel 35 are disposed along a first direction B1. The side on which the wind-up wheel 35 is disposed is one side, and the side on which the electric motor 20 is disposed is the other side. The plunger 40 is movable between the one side and the other side in a second direction B2 intersecting the first direction B1.

In this example, the first direction B1 and the second direction B2 are orthogonal to each other, and the first direction B1 may be referred to as a “horizontal direction” and the second direction B2 may be referred to as a “vertical direction”. In the first direction B1, one side may be referred to as a “front side”, and the other side may be referred to as a “rear side”. In the second direction B2, one side may be referred to as an “upper side”, and the other side may be referred to as a “lower side”.

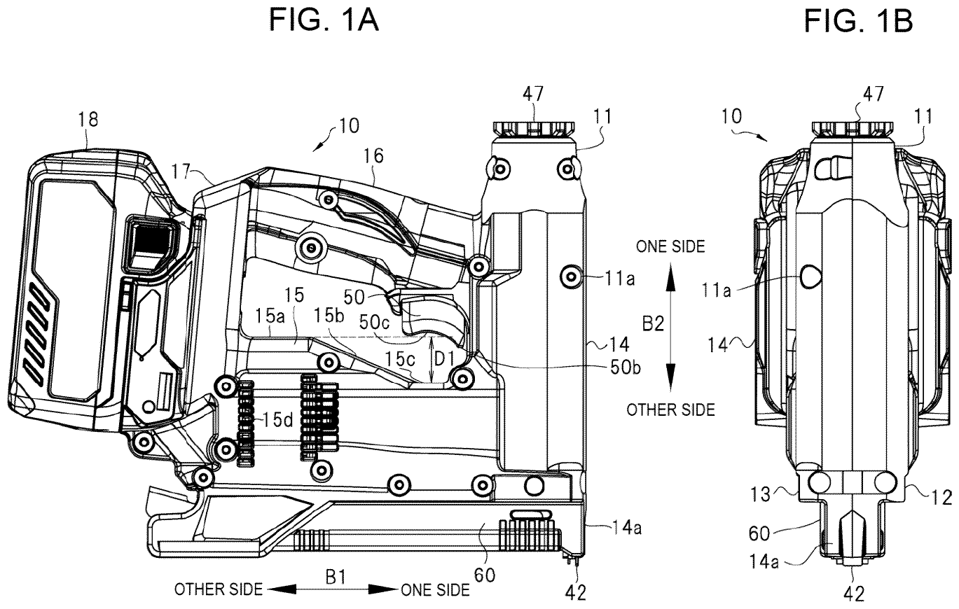

As shown in FIGS. 1A-1B, the working machine 10 includes a housing 11. The housing 11 houses the electric motor 20, the gearbox 25, the pinion shaft 30, the wind-up wheel 35, the plunger 40, and the spring 45, and supports the trigger 50. The housing 11 is made of metal and synthetic resin.

As shown in FIG. 1A, the housing 11 includes a right housing member 12 and a left housing member 13 assembled with each other from both sides of a plane (vertical plane in this example) including the first direction B1 and the second direction B2. A plurality of holes 11a is formed in the right housing member 12 in the horizontal direction. When the right housing member 12 and the left housing member 13 are fastened in an assembled state with fasteners (for example, screws, bolts, or the like) inserted into the plurality of holes 11a, the right housing member 12 and the left housing member 13 form the integrated housing 11. The right housing member 12 is an example of a first housing member, and the left housing member 13 is an example of a second housing member.

As shown in FIG. 1B, in the housing 11, a portion housing the plunger 40 and the spring 45 is a main body portion 14, a portion housing the electric motor 20, the gearbox 25, the pinion shaft 30, and the wind-up wheel 35 is a motor case 15, and a portion where the trigger 50 is provided is a handle 16. The main body portion 14 is an example of a first support portion, and the motor case 15 is an example of a second support portion. A rear end portion of the handle 16 extends downward and is coupled to the motor case 15. A controller 52 that controls driving of the electric motor 20 is disposed inside the rear end portion of the handle 16. The controller 52 is a control unit having a microcomputer and configured to control driving of the electric motor 20 according to signals received from a microswitch 55, a trigger switch 51, and a plunger detection switch 54.

The main body portion 14 has a shape extending in the vertical direction. An ejection unit 14a having an ejection path for ejecting one nail 61 is provided outside the main body portion 14, and the ejection unit 14a is fixed to the main body portion 14.

The motor case 15 has a shape extending in the horizontal direction from the lower side of the main body portion 14. The handle 16 is an example of a handle portion, and has a shape extending in the horizontal direction from the upper side of the main body portion 14. The motor case 15 and the handle 16 have characteristic shapes inclined to the front side, which will be described later. In the motor case 15, a vent hole 15d is formed at a position corresponding to the electric motor 20.

An attachment portion 17 is provided on the rear side of the motor case 15 and the handle 16. A battery pack 18 for supplying power to the electric motor 20 is attached to the attachment portion 17. The battery pack 18 is a DC power supply. The battery pack 18 has a plurality of battery cells, and the battery cells include a lithium ion battery, a nickel hydrogen battery, a lithium ion polymer battery, a nickel cadmium battery, and the like.

A magazine 60 holding a plurality of staple-shaped nails 61 (see FIG. 6) in a state of the nails 61 being aligned in line in the horizontal direction is attached to the lower side of the motor case 15. The magazine 60 is supported by the motor case 15 and the ejection unit 14a.

As shown in FIG. 2, a remaining nail detection bar 63 operated when the remaining amount of the nails 61 reaches a predetermined amount or less (zero in this example) is provided at a lower portion of the motor case 15. The remaining nail detection bar 63 is an example of a remaining amount detection unit. The magazine 60 has a feeder 62 for feeding the nail 61 to the ejection unit 14a. The feeder 62 and the remaining nail detection bar 63 are coupled to each other, and when the feeder 62 moves to the front side to feed out the nail 61 and the remaining amount of the nails 61 reaches zero, the remaining nail detection bar 63 also moves to the front side.

In the motor case 15, the electric motor 20, the gearbox 25, the pinion shaft 30, and the wind-up wheel 35 are disposed coaxially from the rear side to the front side along a center axis Al which is a virtual line extending in the first direction (horizontal direction).

The electric motor 20 has a rotor and a stator. When power is supplied, the rotor rotates, and a motor shaft attached to the rotor rotates. The electric motor 20 is, for example, a brushless motor, and has a flat shape with an outer diameter larger than a length in the axial direction.

The gearbox 25 is an example of a deceleration unit, and includes an input element, a planetary gear mechanism, and an output element. The input element is coupled to the motor shaft of the electric motor 20, and the output element is splined with the pinion shaft 30. When driving force obtained as a result of rotation of the motor shaft is transmitted to the input element, the driving force is decelerated by the planetary gear mechanism, transmitted to the output element, and transmitted to the pinion shaft 30 splined to the output element. The outer diameter of the gearbox 25 is smaller than the outer diameter of the electric motor 20.

In the present example, the electric motor 20 is an example of a drive unit, and is a flat brushless motor, and has a shorter length in the axial direction than that of a brushed motor having the same output. As described above, the arrangement space of the gearbox 25 and the pinion shaft 30 can be ensured by a space obtained by the short length of the electric motor 20 in the axial direction. The gearbox 25 of the present example employs two-stage deceleration.

The pinion shaft 30 is an example of a coupling shaft coaxially coupling the gearbox 25 and the wind-up wheel separated in the horizontal direction. The pinion shaft 30 transmits rotational force transmitted from the gearbox 25 to the wind-up wheel 35. The outer diameter of the pinion shaft 30 is smaller than the outer diameter of the gearbox 25, and the pinion shaft 30 is disposed at a position (immediately below in the present example) overlapping at least with the trigger 50 in the vertical direction. The pinion shaft 30 is made of metal.

The wind-up wheel 35 is an example of an operation unit, and is operated by the output of the gearbox 25 transmitted through the pinion shaft 30 to move the plunger 40. The wind-up wheel 35 of the present example is a single disk coaxial with the gearbox 25, and rotates counterclockwise. The wind-up wheel 35 is made of metal.

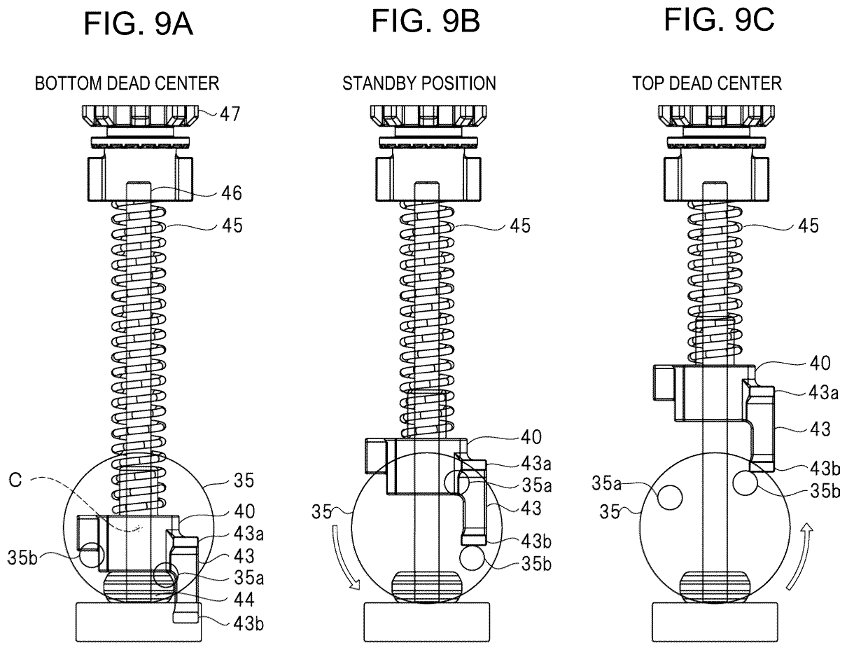

The wind-up wheel 35 has a plurality of protrusions on the front surface. The plurality of protrusions in the present example includes a first pin 35a and a second pin 35b. The protruding length of the first pin 35a from the disk surface is shorter than the protruding length of the second pin 35b from the disk surface. As shown in FIG. 9, the first pin 35a and the second pin 35b are disposed at equal distances (i.e., on concentric circles) from the center point of the wind-up wheel 35 (in the present example, spaced apart from each other at an angle of 90° in the rotation direction).

Next, focusing on the second direction (vertical direction), a top holder 48 is disposed on the upper side and a bottom holder 49 is disposed on the lower side in the main body portion 14. A guide shaft 46 is disposed between the top holder 48 and the bottom holder 49. The top holder 48, the bottom holder 49, and the guide shaft 46 are made of metal.

Into the plunger 40, which is an example of a movement unit, the guide shaft 46 is inserted, and the plunger 40 is movable in the vertical direction along the guide shaft 46 between the top holder 48 and the bottom holder 49. A driver blade 41 having a shape extending to the lower side and configured to strike one nail 61 in the ejection path is fixed to the front side of the plunger 40. The plunger 40 and the driver blade 41 are made of steel.

A rack 43 is fixed to the rear side of the plunger 40, and the rack 43 has a plurality of engagement portions engageable with the plurality of protrusions of the wind-up wheel 35. The plurality of engagement portions of the present example includes a first engagement portion 43a and a second engagement portion 43b. The protruding length of the first engagement portion 43a from the rack 43 is longer than the protruding length of the second engagement portion 43b from the rack 43. The first engagement portion 43a has such a length that the first engagement portion 43a can be engaged with the first pin 35a and cannot be engaged with the second pin 35b. The second engagement portion 43b has such a length that the second engagement portion 43b can be engaged with the second pin 35b and cannot be engaged with the first pin 35a.

The spring 45 is provided between the top holder 48 and the plunger 40, and the guide shaft 46 is inserted into the spring 45. The spring 45 is an example of a biasing unit, is, for example, a compression coil spring made of metal, and can expand and contract in the vertical direction. The spring 45 applies downward biasing force to the plunger 40.

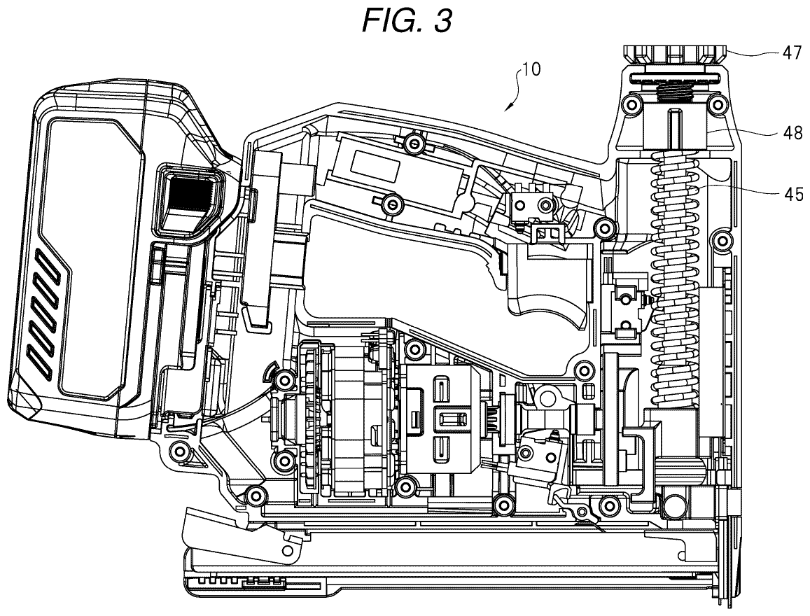

The biasing force of the spring 45 is adjustable, and as shown in FIG. 3, by rotating and screwing a shaft head 47 provided at the top of the guide shaft 46 from the state of FIG. 2, the top holder 48 moves to the lower side, the spring 45 is compressed, and the biasing force increases. When the biasing force increases in this manner, the speed at which the plunger 40 and the driver blade 41 move to the lower side increases, so that the force of driving the nail 61 increases.

Returning to FIG. 2, a bumper 44, which is an example of a buffering unit, is disposed between the plunger 40 and the bottom holder 49. The bumper 44 absorbs part of the kinetic energy of the plunger 40 moving to the lower side by the biasing force of the spring 45 to prevent damage to the plunger 40. The bumper 44 is made of synthetic rubber. The bumper 44 is located on the upper side with respect to the center axis Al of the electric motor 20, the gearbox 25, the pinion shaft 30, and the wind-up wheel 35.

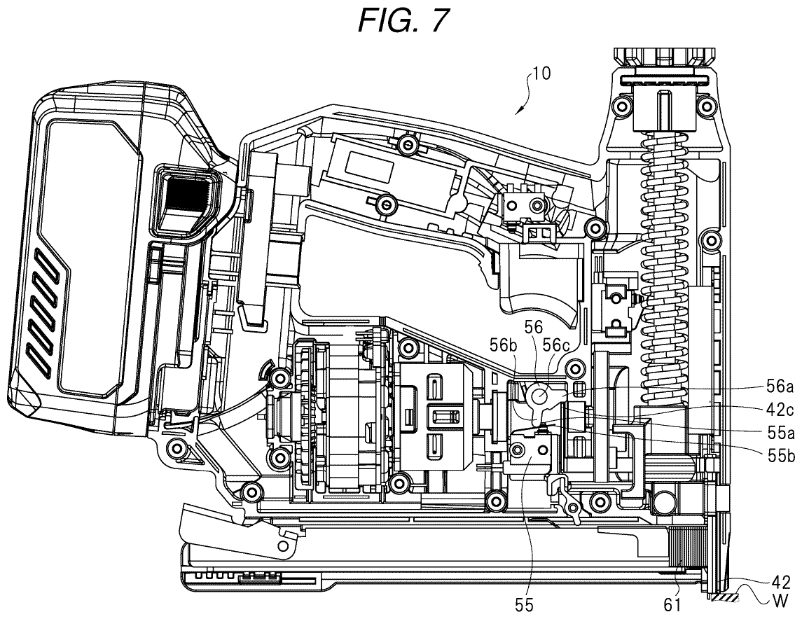

A push lever 42, which is an example of a contact unit, is disposed on the front side of the driver blade 41. The downward biasing force is applied to the push lever 42, but when the push lever 42 contacts a partner member W into which the nail 61 is driven (see FIG. 7), the push lever 42 moves to the upper side against the biasing force.

When this movement is detected by the microswitch 55, the electric motor 20 can be driven, i.e., the nail 61 can be driven. In other words, if this movement is not detected by the microswitch 55, the electric motor 20 cannot be driven, that is, the nail 61 cannot be driven. That is, the push lever 42 forms a safety mechanism for preventing the nail 61 from being ejected although the push lever 42 does not contact the partner member W.

The push lever 42 has a crank shape including a first vertical portion 42a extending to the upper side from the lower end contacting the partner member W, a horizontal portion 42b extending to the rear side from the upper end of the first vertical portion 42a, and a second vertical portion 42c extending to the upper side from the rear end of the horizontal portion 42b.

As shown in FIG. 7 described later, the second vertical portion 42c contacts a first rotary member 56, and the first rotary member 56 rotates counterclockwise, so that a detection sensor 55a of the microswitch 55 is turned on. As a result, movement of the push lever 42, i.e., contact with the partner member W, is detected by the microswitch 55.

The trigger 50 is an example of a manipulating unit, and is manipulated by a worker to control driving of the electric motor 20. The trigger 50 extends so as to protrude to the lower side in the vertical direction from the bottom surface of the handle 16 on the front side, and is disposed on the upper side and the front side with respect to the gearbox 25. The trigger switch 51 that detects operation of the trigger 50 is provided inside the handle 16. The trigger 50 is supported by the handle 16 in a state of being movable in the up-down direction relative to the handle 16, and is provided with a spring (not shown) interposed between the handle 16 and the trigger 50 and biasing the trigger 50 downward. The bottom surface of the trigger 50 has a shape curved in accordance with the shape of a finger F of the worker. The distance in the second direction B2 between a lower end portion 50b of the trigger 50 and an upper end portion (most recessed portion) 50c of the bottom surface of the trigger 50 is set to 7 mm as an example, but can be appropriately changed in a range of 0 mm or more and 30 mm.

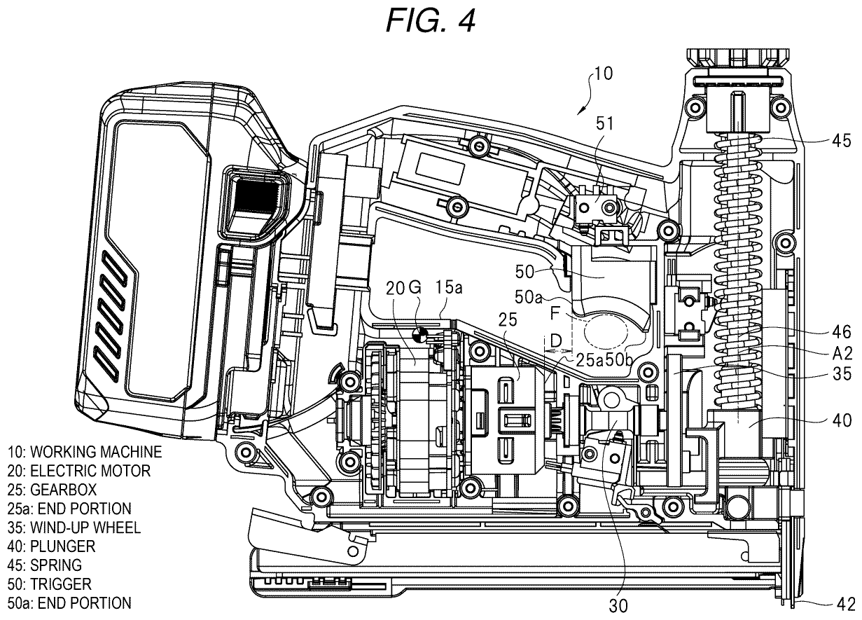

Next, a use example of the working machine 10 will be described with reference to FIGS. 4 and 9. In a state in which the push lever 42 is not brought into contact with the partner member W or the trigger 50 is not manipulated by the worker, the electric motor 20 is not driven, and the plunger 40 is at a standby position as shown in FIG. 9B.

When the worker manipulates the trigger 50 by pulling the trigger 50 to the upper side with the finger F on the lower surface of the trigger 50 as shown in FIG. 4 in a state in which the push lever 42 contacts the partner member W and movement of the push lever 42 is detected by the microswitch 55, operation of the trigger 50 is detected by the trigger switch 51. As a result, power is supplied to the electric motor 20, and the electric motor 20 is actuated. The rotational force of the electric motor 20 is decelerated by the gearbox 25, and is transmitted to the wind-up wheel 35 through the pinion shaft 30.

As shown in FIG. 9C, when the wind-up wheel 35 to which the rotational force is transmitted rotates counterclockwise, the second pin 35b protruding from the wind-up wheel 35 is engaged with the second engagement portion 43b provided in the rack 43, the rack 43 and the plunger 40 move to the upper side, and the plunger 40 is brought into a state of being at the top dead center. Note that when the plunger 40 is at the top dead center, the plunger 40 turns on the plunger detection switch 54.

When the wind-up wheel 35 further rotates counterclockwise from this state, the second pin 35b and the second engagement portion 43b are disengaged from each other, and as shown in FIG. 9A, the plunger 40 moves to the lower side by the biasing force of the spring 45, the driver blade 41 fixed to the plunger 40 strikes the nail 61, the plunger 40 comes into contact with the bumper 44, and the plunger 40 is brought into a state of being at the bottom dead center.

Thereafter, when the wind-up wheel 35 further rotates counterclockwise, the first pin 35a protruding from the wind-up wheel 35 is engaged with the first engagement portion 43a provided in the rack 43, the rack 43 and the plunger 40 move to the upper side, and the plunger 40 is brought into a state of being at the standby position as shown in FIG. 9B.

In general, a working machine is provided with a plurality of wind-up wheels in order to increase the stroke of a plunger, but in this working machine 10, only the single wind-up wheel 35 is provided. However, in this working machine 10, the plurality of protrusions (first pin 35a and second pin 35b) provided on the single wind-up wheel 35 is engaged with the plurality of engagement portions (first engagement portion 43a and second engagement portion 43b) provided on the rack 43 fixed to the plunger 40, so that the plunger 40 can be moved to the upper side in a plurality of stages even when the single wind-up wheel 35 is provided.

In the present example, the plunger 40 can be moved to the upper side in two stages of a first stage in which the first pin 35a and the first engagement portion 43a are engaged with each other and the plunger 40 moves upward from the bottom dead center shown in FIG. 9A to the standby position shown in FIG. 9B and a second stage in which the second pin 35b and the second engagement portion 43b are engaged with each other and the plunger 40 moves upward to the top dead center shown in FIG. 9C.

Here, the relative positional relationship between the plurality of protrusions and the plurality of engagement portions varies depending on rotation of the wind-up wheel 35, but in the state of the bottom dead center shown in FIG. 9A, the plurality of engagement portions is disposed so as to be different from each other in the distance from the rotation center C of the wind-up wheel 35. In the present example, the first engagement portion 43a is close to the rotation center C, and the second engagement portion 43b is far from the rotation center C. Moreover, the second engagement portion 43b is located outside the outer periphery of the wind-up wheel 35 and on the lower side with respect to the bumper 44.

Accordingly, the stroke of the plunger 40 can be increased even in the case of the single wind-up wheel 35. In addition, since it is not necessary to provide the plurality of wind-up wheels, the number of components can be reduced, and a manufacturing cost can be reduced. Further, since the wind-up wheel 35 is coaxial with the electric motor 20 and is disposed inside the outer periphery of the electric motor 20, the working machine 10 can be reduced in size.

Here, a characteristic configuration of the working machine 10 of the present embodiment will be described with reference to FIGS. 4 and 1(B).

As shown in FIG. 4, in the working machine 10, a front end portion 25a of the gearbox 25 is located on the rear side with respect to a rear end portion 50a of the trigger 50 in the horizontal direction. That is, the front end portion 25a of the gearbox 25 and the rear end portion 50a of the trigger 50 are separated from each other by an interval D. In other words, the distance from the center axis A2 of the guide shaft 46 to the front end portion 25a of the gearbox 25 is shorter by the interval D than the distance from the center axis A2 to the rear end portion 50a of the trigger 50.

In the working machine 10, the outer diameter of the pinion shaft 30 is smaller than the outer diameter of the gearbox 25, and the pinion shaft 30 and at least part of the trigger 50 are disposed at overlapping positions in the horizontal direction. In the present example, the pinion shaft 30 is disposed immediately below the trigger 50.

In general, the center of gravity of the working machine is in the vicinity of a heavy object such as a gearbox or an electric motor, and the center of gravity G of the working machine 10 of the present example is around the upper side of the electric motor 20 as shown in the drawing. If the center of gravity G, the trigger 50, and the handle 16 are separated from each other, handleability is degraded, and the worker tends to be tired. Therefore, in the working machine 10 of the present embodiment, the pinion shaft 30 is coaxially provided between the gearbox 25 and the wind-up wheel 35, and the trigger 50 is disposed on the upper side of the pinion shaft 30. In addition, the center of gravity is located on the one side with respect to a shaft housing surface 15c in the second direction B2. As a result, since the center of gravity G and the trigger 50 can be brought close to each other, workability can be improved.

When the outer diameters of the electric motor 20, the gearbox 25, the pinion shaft 30, and the wind-up wheel 35 are compared, there is a relationship of the outer diameter of the electric motor 20>the outer diameter of the wind-up wheel 35>the outer diameter of the gearbox 25>the outer diameter of the pinion shaft 30. Therefore, as shown in FIG. 1B, on the upper surface of the motor case 15 housing these components, the shaft housing surface 15c of the portion housing the pinion shaft 30 can be provided at a lower position in the vertical direction than a motor housing surface 15a of the portion housing the electric motor 20. The shaft housing surface 15c is an example of a coupling shaft housing surface and a constricted portion, and the motor housing surface 15a is an example of a drive unit housing surface.

A gear housing surface 15b of the portion housing the gearbox 25 is inclined to the lower side from the rear end contacting the motor housing surface 15a to the front end contacting the shaft housing surface 15c. That is, the upper surface of the motor case 15 has a constricted shape in which the shaft housing surface 15c is recessed from the motor housing surface 15a. As a result, as shown in FIG. 4, a space into which the finger F is inserted can be sufficiently ensured between the trigger 50 and the shaft housing surface 15c.

As shown in FIG. 1B, similarly to the case where the upper surface of the motor case 15 is inclined to the lower side from the rear side to the front side, the handle 16 is also inclined to the lower side from the rear side to the front side. Specifically, the lower surface 16a of the handle 16 is inclined to the lower side from the rear side to the front side, and the upper surface 16b of the handle 16 is inclined to the lower side from the rear side to the front side. In particular, also in a region immediately above the trigger 50 on the upper surface 16b of the handle 16 (region where the arrangement region in the first direction B1 overlaps with the trigger 50), the upper surface 16b of the handle 16 is inclined to the lower side from the rear side to the front side. As shown in FIG. 4, the lower end portion 50b of the trigger 50 is located on the lower side with respect to the motor housing surface 15a in the vertical direction. With these configurations, since the handle 16 and the trigger 50 can be brought close to the center of gravity G, it is possible to further contribute to improvement in the workability as described above. Note that the distance D1 between the motor housing surface 15a and the shaft housing surface 15c in the second direction B2 is, for example, 25 mm. However, if the distance D1 is 15 mm or more, even when the lower end portion 50b of the trigger 50 is located on the lower side with respect to the motor housing surface 15a, the space into which the finger F is inserted can be sufficiently ensured.

Since the outer diameter of the pinion shaft 30 is smaller than that of the gearbox 25, there is a space around the pinion shaft 30 in the motor case 15. Therefore, in a state in which the right housing member 12 and the left housing member 13 of the housing 11 are disassembled and one thereof is removed (in the present example, the state of FIG. 4 in which the left housing member 13 is removed), the pinion shaft 30 can be easily pinched by inserting a finger into the space.

Since the pinion shaft 30 is coupled to the wind-up wheel 35 and is splined to the gearbox 25, the pinion shaft 30 and the wind-up wheel 35 can be detached by pulling out the pinion shaft 30 from the gearbox 25 toward the front side in a state of the pinion shaft 30 being pinched. It is conceivable that the first pin 35a and the second pin 35b of the wind-up wheel 35 are damaged by impact or the like at the time of striking, but since the wind-up wheel 35 can be easily removed as described above, maintenance time and effort can be saved.

Next, the microswitch 55 will be described in detail. The microswitch 55 is an example of an operation detection unit capable of detecting operation of a plurality of members. As shown in FIGS. 2 to 4, the microswitch 55 is disposed in a space located at the position of the pinion shaft 30 between the gearbox 25 and the wind-up wheel 35 and generated in the motor case 15 at the position of the shaft housing surface 15c because the outer diameter of the pinion shaft 30 is smaller than the outer diameter of the gearbox 25.

The microswitch 55 of the present example can detect operation of the push lever 42 and the remaining nail detection bar 63 as the plurality of members. Specifically, the microswitch 55 detects operation of the push lever 42 transmitted through the first rotary member 56, and detects operation of the remaining nail detection bar 63 transmitted through a second rotary member 57.

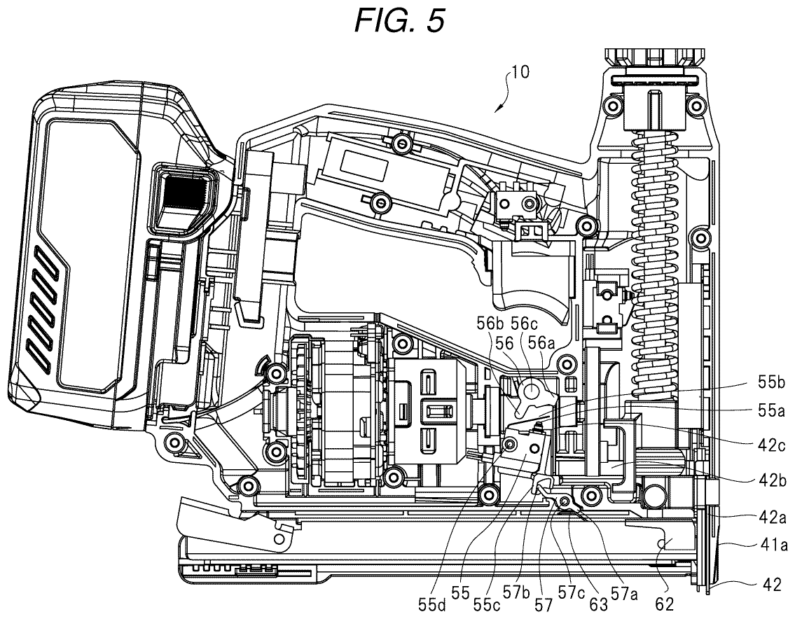

The first rotary member 56 is disposed on the right side of the pinion shaft 30 in front view, and in FIGS. 2 to 4, is hidden behind the pinion shaft 30 and cannot be seen. Therefore, the following description will be made with reference to FIGS. 5 to 8 in which the pinion shaft 30 is omitted.

As shown in FIG. 5, the microswitch 55 is supported in the motor case 15 so as to be rotatable about a rotary shaft 55d in the vertical plane.

On the upper side of the microswitch 55, the detection sensor 55a that detects operation of the push lever 42 when the first rotary member 56 contacts the detection sensor 55a is provided. On the upper side of the microswitch 55, a plate spring 55b is provided.

Further, on the lower side of the microswitch 55, an engagement portion 55c for detecting operation of the remaining nail detection bar 63 and turning the microswitch 55 by engaging with the second rotary member 57 is provided. The engagement portion 55c has a front wall on the front side and a rear wall on the rear side as portions with which the second rotary member 57 is engaged.

The first rotary member 56 is an example of a first transmission unit, and can transmit operation of the push lever 42 to the microswitch 55. The first rotary member 56 is supported in the motor case 15 so as to be rotatable about a rotary shaft 56c in the vertical plane. The first rotary member 56 has two contact pieces. The contact piece on the front side is a push lever contact piece 56a configured to contact the second vertical portion 42c of the push lever 42. The contact piece on the rear side is a plate spring contact piece 56b for bringing the plate spring 55b into contact with the detection sensor 55a of the microswitch 55.

The second rotary member 57 is an example of a second transmission unit, and can transmit operation of the remaining nail detection bar 63 to the microswitch 55. The second rotary member 57 is supported in the motor case 15 so as to be rotatable about a rotary shaft 57c in the vertical plane. The second rotary member 57 has two contact pieces. The contact piece on the front side is a remaining nail detection bar contact piece 57a configured to contact the remaining nail detection bar 63. The contact piece on the rear side is an engagement portion contact piece 57b configured to contact the engagement portion 55c of the microswitch 55.

Although FIG. 5 described above is a view showing a state in which the nail 61 is not held by the magazine 60, FIG. 6 described next is a view showing a state in which the nail 61 is held by the magazine 60. In this state, the remaining nail detection bar 63 coupled to the feeder 62 is located on the rear side with respect to that in the state of FIG. 5, and does not contact the remaining nail detection bar contact piece 57a of the second rotary member 57. Therefore, the second rotary member 57 does not rotate and is in a substantially upright state, and the engagement portion contact piece 57b contacts the front wall of the engagement portion 55c of the microswitch 55. As a result, the microswitch 55 does not rotated, and is in a substantially upright state.

Here, as shown in FIG. 7, when the worker brings the push lever 42 into contact with the partner member W, the push lever 42 moves to the upper side, and the second vertical portion 42c thereof pushes up the push lever contact piece 56a of the first rotary member 56. Then, the first rotary member 56 rotates counterclockwise, the plate spring contact piece 56b thereof pushes down the plate spring 55b, and the plate spring 55b comes into contact with the detection sensor 55a of the microswitch 55. As a result, operation of the push lever 42 is detected by the microswitch 55.

That is, the microswitch 55 is at a detectable position (substantially upright state shown in FIGS. 6 and 7) at which operation of the push lever 42 can be detected when operation of the remaining nail detection bar 63 is not transmitted by the second rotary member 57.

Note that when the push lever 42 no longer contacts the partner member W, the push lever 42 is lowered by the downward biasing force, and the first rotary member 56 is rotated clockwise by the upward biasing force of the plate spring 55b and is brought into the state of FIG. 6.

FIG. 5 is a view showing a state in which the nail 61 is not held by the magazine 60. In this state, the remaining nail detection bar 63 coupled to the feeder 62 is located on the front side with respect to that in the state of FIG. 6, and contacts the remaining nail detection bar contact piece 57a of the second rotary member 57. Therefore, the second rotary member 57 rotates counterclockwise as compared with the state of FIG. 6 and is in an inclined state, and the engagement portion contact piece 57b thereof contacts the rear wall of the engagement portion 55c of the microswitch 55. As a result, the microswitch 55 rotates clockwise, and is in an inclined state.

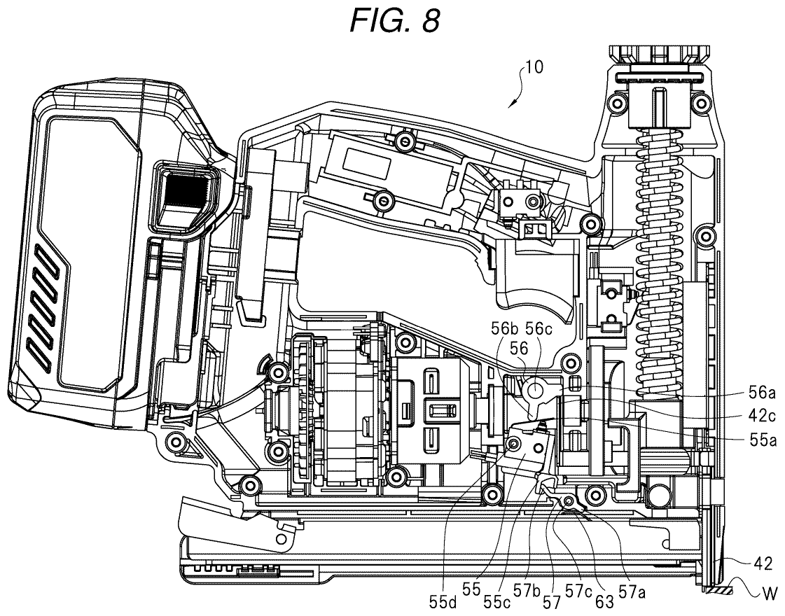

Here, as shown in FIG. 8, when the worker brings the push lever 42 into contact with the partner member W, the push lever 42 moves to the upper side, and the second vertical portion 42c thereof pushes up the push lever contact piece 56a of the first rotary member 56. Then, the first rotary member 56 rotates counterclockwise, and the plate spring contact piece 56b thereof pushes down the plate spring 55b. However, since the microswitch 55 is in the inclined state, the plate spring 55b does not contact the detection sensor 55a of the microswitch 55, and operation of the push lever 42 is not detected by the microswitch 55.

That is, the microswitch 55 is at an undetectable position (inclined state shown in FIGS. 5 and 8) at which operation of the push lever 42 cannot be detected when operation of the remaining nail detection bar 63 is transmitted by the second rotary member 57. Therefore, the microswitch 55 can be displaced between the detectable position and the undetectable position.

As described above, in a state in which the microswitch 55 is at the undetectable position, the electric motor 20 is not actuated even when the trigger 50 is manipulated. In other words, in a state in which the nail 61 is not held by the magazine 60, the ejection operation is not performed, and so-called idling can be prevented.

As described above, in the working machine 10 of the present embodiment, the outer diameter of the pinion shaft 30 coupling the gearbox 25 and the wind-up wheel 35 is smaller than the outer diameter of the gearbox 25 between the gearbox 25 and the wind-up wheel 35, so that the space can be formed in the motor case 15 and the microswitch 55 can be disposed in the space. Since the microswitch 55 is a common detection mechanism capable of detecting operation of the push lever 42 and operation of the remaining nail detection bar 63, it is not necessary to separately provide a detection mechanism for detecting both these operations. This makes it possible to effectively utilize the space and reduce the manufacturing cost.

Further, since the remaining nail detection bar 63 is provided at the lower portion of the motor case 15 of the housing 11, it is not necessary to provide a sensor for detecting the remaining nails in the magazine 60, and the wiring for the sensor does not extend over the main body of the working machine 10 and the magazine 60, so that the wiring does not become an obstacle at the time of maintenance such as disassembly.

In the first rotary member 56, the length of the push lever contact piece 56a from the rotation center is longer than the length of the plate spring contact piece 56b from the rotation center. Since a small stroke of the push lever 42 is converted into large movement of the plate spring contact piece 56b by the first rotary member 56, movement of the push lever 42 can be reliably detected.

The present invention is not limited to the embodiment above, and various changes can be made without departing from the gist of the present invention.

For example, the stopper is not limited to the staple-shaped nail 61, and may be a bar-shaped nail, an arch-shaped tacker, or a rivet.

The intersection between the first direction B1 and the second direction B2 is not limited to orthogonal intersection, and may be inclined intersection.

Displacement of the microswitch 55 from the detectable position (FIG. 7) to the undetectable position (FIG. 8) may not be rotation but may be movement in parallel in the first direction Bl or the second direction B2.

The remaining nail detection bar 63 may be operated not when the remaining amount of the nails 61 is zero, but when the remaining amount of the nails 61 is a predetermined amount or less.

The battery pack 18 is not limited to the DC power supply, and may be an AC power supply.

The standby position of the plunger 40 is not limited to the position between the bottom dead center and the top dead center as shown in FIG. 9B, and may be the bottom dead center shown in FIG. 9A.

### REFERENCE SIGNS LIST

10 Working machine
11 Housing
14 Main body portion
15 Motor case
16 Handle
20 Electric motor
25 Gearbox
30 Pinion shaft
35 Wind-up wheel
40 Plunger
41 Driver blade
50 Trigger
55 Microswitch
56 First rotary member
57 Second rotary member
60 Magazine
61 Nail
63 Remaining nail detection bar
A1 Center axis
A2 Center axis
B1 First direction
B2 Second direction
W Partner member

1. A working machine comprising:
a movement unit that moves downward to strike a stopper;
a biasing unit that biases the movement unit downward;
an operation unit that lifts the movement unit upward against biasing force of the biasing unit;
a drive unit having a drive shaft extending in a front-rear direction;
a deceleration unit disposed between the drive unit and the operation unit in the front-rear direction and configured to decelerate and output driving force of the drive unit;
a transmission unit that transmits the output of the deceleration unit to the operation unit;
a housing having a drive unit case housing the drive unit, the transmission unit, and the operation unit, and a handle located above the drive unit case and extending in the front-rear direction; and
a manipulating unit protruding downward from the handle, wherein
the drive unit case has a drive unit housing surface which is an upper surface of a portion housing the drive unit and a constricted portion which is an upper surface of a portion housing the transmission unit and is located lower than the drive unit housing surface,
the manipulating unit is disposed so as to overlap with the constricted portion in an up-down direction, and
a lower end of the manipulating unit is disposed lower than the drive unit housing surface.

2. The working machine according to claim 1, wherein the handle is inclined with respect to an axis of the drive shaft so as to extend downward on a front side.

3. The working machine according to claim 1, wherein the drive unit has an outer diameter larger than that of the operation unit.

4. The working machine according to claim 1, wherein a center of gravity is disposed lower than the drive unit housing surface.

5. The working machine according to claim 4, wherein the center of gravity is disposed higher than an upper end of the drive unit.

6. The working machine according to claim 5, wherein the center of gravity is disposed in rear of the manipulating unit.

7. The working machine according to claim 1, wherein
the operation unit is disposed coaxially with the drive unit and rotates to move the movement unit, and
the constricted portion is disposed lower than an upper end of the operation unit.

8. The working machine according to claim 1, wherein the manipulating unit is disposed in rear of a rear end of the operation unit and in front of a front end of the deceleration unit.

9. The working machine according to claim 1, further comprising a controller that controls driving of the drive unit, wherein
the controller is disposed in rear of the drive unit such that a lower end of the controller is located lower than the drive unit housing surface.

10. The working machine according to claim 9, wherein
a rear end portion of the handle houses the controller, extends in the up-down direction, and is coupled to the drive unit case, and
a rear end of the drive unit is disposed in rear of a front surface of the rear end portion of the handle.

11. The working machine according to claim 10, further comprising a battery pack attached to the rear end portion of the handle, wherein
an upper end of the battery pack is located higher than an upper end of the handle.

12. The working machine according to claim 1, wherein the transmission unit has a built-in element disposed on an upper side in the constricted portion and disposed on a lower side in the constricted portion.

13. The working machine according to claim 12, further comprising a contact unit to be operated by contacting a partner member, wherein
the built-in element is provided to detect operation of the contact unit and control driving of the drive unit.

14. The working machine according to claim 1, further comprising a contact unit to be operated by contacting a partner member, wherein
a detection unit that detects operation of the contact unit is provided between the operation unit and the deceleration unit in the front-rear direction.

15. The working machine according to claim 1, further comprising a trigger switch provided inside the handle to detect operation of the manipulating unit.

16. The working machine according to claim 1, wherein a distance between the drive unit housing surface and the constricted portion in the up-down direction is 15 mm or more.

17. The working machine according to claim 1, further comprising an ejection unit fixed to the housing and configured to eject the stopper struck by the movement unit, wherein
a lower end of the manipulating unit is disposed lower than a center between an upper end of the housing and a lower end of the ejection unit in the up-down direction.

18. A working machine comprising:
a movement unit that moves downward to strike a stopper;
a biasing unit that biases the movement unit downward;
an operation unit that lifts the movement unit upward against biasing force of the biasing unit;
a drive unit having a drive shaft extending in a front-rear direction;
a deceleration unit disposed between the drive unit and the operation unit in the front-rear direction and configured to decelerate and output driving force of the drive unit;
a transmission unit that transmits the output of the deceleration unit to the operation unit;
a housing having a drive unit case housing the drive unit, the transmission unit, and the operation unit, and a handle located above the drive unit case and extending in the front-rear direction;
a manipulating unit protruding downward from the handle; and
an ejection unit fixed to the housing and configured to eject the stopper struck by the movement unit, wherein
a lower end of the manipulating unit is disposed lower than a center between an upper end of the housing and a lower end of the ejection unit in an up-down direction.

19. A working machine comprising:
a movement unit that moves downward to strike a stopper;
a biasing unit that biases the movement unit downward;
an operation unit that lifts the movement unit upward against biasing force of the biasing unit;
a drive unit having a drive shaft extending in a front-rear direction;
a deceleration unit disposed between the drive unit and the operation unit in the front-rear direction and configured to decelerate and output driving force of the drive unit;
a transmission unit that transmits the output of the deceleration unit to the operation unit;
a housing having a drive unit case housing the drive unit, the transmission unit, and the operation unit, and a handle located above the drive unit case and extending in the front-rear direction; and
a manipulating unit protruding downward from the handle, wherein
the drive unit case has a drive unit housing surface which is an upper surface of a portion housing the drive unit and a constricted portion which is an upper surface of a portion housing the transmission unit and is located lower than the drive unit housing surface,
the operation unit is disposed coaxially with the drive unit and rotates to move the movement unit, and
the constricted portion is disposed lower than an upper end of the operation unit.
